(19) United States
(12) Patent Application Publication
(10) Pub. No.: US 2017/0198243 A1
(43) Pub. Date: Jul. 13, 2017

(54) LIQUID CLEANING AGENT CONTAINING LIQUID AND SOLID ENZYME FORMULATIONS

(71) Applicant: Henkel AG & Co. KGaA, Duesseldorf (DE)

(72) Inventors: Nina Mussmann, Willich (DE); Thomas Eiting, Duesseldorf (DE); Noelle Wrubbel, Duesseldorf (DE); Thorsten Bastigkeit, Wuppertal (DE)

(73) Assignee: Henkel AG & Co. KGaA, Duesseldorf (DE)

(21) Appl. No.: 15/315,173

(22) PCT Filed: Jun. 18, 2015
(86) PCT No.: PCT/EP2015/063666

§ 371 Date: Nov. 30, 2016

(30) Foreign Application Priority Data
Jun. 30, 2014 (DE) 10 2014 212 643.6

(51) Int. Cl. C11D 3/386; C11D 17/00; C11D 3/37; C11D 3/36; C11D 17/04; C11D 11/00; C11D 3/20

(52) U.S. Cl. CPC C11D 3/38618; C11D 11/0023; C11D 17/0013; C11D 3/2065; C11D 3/362; C11D 17/043; C11D 3/378; C11D 17/046

(57) ABSTRACT

Liquid cleaning agents and methods for cleaning are provided herein. In one embodiment, the liquid cleaning agent includes at least one liquid enzyme formulation which includes at least one protease and/or at least one amylase. The liquid cleaning agent further includes at least one solid enzyme formulation which includes at least one protease and/or at least one amylase, wherein the solid enzyme formulation is homogeneously suspended in the liquid cleaning agent. In another embodiment, the method includes the step of providing the liquid cleaning agent. The method further includes the step of dosing the liquid cleaning agent into the interior of the dishwasher.

### CROSS-REFERENCE TO RELATED APPLICATIONS

This application is a U.S. National-Stage entry under 35 U.S.C. §371 based on International Application No. PCT/EP2015/063666, filed Jun. 18, 2015, which was published under PCT Article 21(2) and which claims priority to German Application No. 10 2014 212 643.6, filed Jun. 30, 2014, which are all hereby incorporated in their entirety by reference.

### TECHNICAL FIELD

This disclosure is directed to a liquid cleaning agent, preferably a dishwashing detergent, preferably a machine dishwasher detergent, containing at least one solid enzyme formulation and at least one liquid enzyme formulation, and to the use of such a cleaning agent.

### BACKGROUND

The most important criterion in the cleaning of hard surfaces, in particular by machine dishwashing, is the cleaning power on various soils which are introduced, in particular in the form of food residues. Although the cleaning power of the dishwasher detergents currently used is fairly high, due to the general trend toward increasing use of low-temperature programs in machine dishwashing the problem arises that many of the customary machine dishwasher detergents have insufficient cleaning power for stubborn soils. Such insufficient cleaning power and the accompanying inadequate cleaning of dishes result in consumer dissatisfaction, so that such soils are pretreated by the consumer, which in turn increases the water and energy consumption. Therefore, there is a general need for machine dishwasher detergents which still have good cleaning power even on stubborn soils.

Cleaning agents for hard surfaces, for example dishwasher detergents, are available to the consumer in a variety of forms. In addition to the traditional solid agents, flowable, in particular liquid to gel-form, cleaning agents have become increasingly important in recent times. The consumer values in particular the rapid solubility and the accompanying rapid availability of the ingredients in the cleaning solution, in particular even in short dishwashing programs and at low temperatures.

Concentrated compositions, in which in particular the water content is reduced compared to conventional compositions, are gaining in importance. Compositions whose water content is preferably low, for example less than 25% by weight, are therefore particularly desirable for the consumer.

In addition, consumers have become accustomed to conveniently dosing preportioned machine dishwasher detergents, and heretofore have used these products primarily in the form of tablets. It is customary to use cold water-soluble films in the form of bags in order to introduce a liquid dishwasher detergent, having the above-mentioned advantages over solid compositions, into a preportioned product. However, there are limits on formula development, since only a limited quantity of water can be incorporated into the product. Exceeding the tolerable quantity of water results in premature dissolution of the enveloping water-soluble film. To ensure good storage stability of these water-soluble containers, water contents of less than 25% by weight are likewise desirable.

Furthermore, liquid formulations have a particularly attractive appearance to the consumer when they contain stably suspended, solid, optionally also colored components. If these solid components contain substances having cleaning activity, and are claimed to have a particularly high performance, this gives the consumer the impression that such a product is more powerful than a product without these solid components.

### BRIEF SUMMARY

Liquid cleaning agents and methods for cleaning are provided herein. In one embodiment, the liquid cleaning agent includes at least one liquid enzyme formulation which includes at least one protease and/or at least one amylase. The liquid cleaning agent further includes at least one solid enzyme formulation which includes at least one protease and/or at least one amylase, wherein the solid enzyme formulation is homogeneously suspended in the liquid cleaning agent.

In another embodiment, the method includes the step of providing the liquid cleaning agent. The method further includes the step of dosing the liquid cleaning agent into the interior of the dishwasher.

### DETAILED DESCRIPTION

The following Detailed Description is merely exemplary in nature and is not intended to limit the various embodiments or the application and uses thereof. Furthermore, there is no intention to be bound by any theory presented in the preceding background or the following detailed description.

The object of the present disclosure, therefore, is to provide a liquid cleaning agent, preferably a dishwashing detergent, preferably a machine dishwasher detergent, which has increased cleaning power, a lower water content, and an attractive appearance.

It has now surprisingly been found that using a combination of liquid enzyme formulations and solid enzyme granules results in improved performance of liquid dishwasher detergents compared to using either a liquid enzyme formulation or a solid enzyme formulation alone. In addition, the use of solid enzyme formulations offers the advantage that the water content in low-water cleaning agent formulations may be further reduced, since liquid enzyme formulations usually have a high water content.

In a first aspect, the present disclosure is therefore directed to a liquid cleaning agent, in particular a machine dishwasher detergent, comprising
(1) at least one liquid enzyme formulation which contains at least one protease and/or at least one amylase; and
(2) at least one solid enzyme formulation, preferably in the form of a granulate, which comprises at least one protease and/or at least one amylase, wherein the solid enzyme formulation is homogeneously suspended in the liquid dishwasher detergent.

A further subject matter of the present disclosure relates to the use of a cleaning agent described herein as a dishwashing detergent, preferably as a machine dishwasher detergent.

Yet a further aspect relates to a method for cleaning dishes in an automatic dishwasher, wherein a cleaning agent as described herein is used, and is dosed into the interior of the dishwasher preferably during a dishwashing program, before the main wash cycle begins or during the course of the main wash cycle.

In various embodiments of the disclosure, temperatures are used in the dishwashing method which are lower than the temperatures customarily used.

“Homogeneously suspended,” as used herein, refers to a suspension which contains the solid enzyme preparation in the form of stably and uniformly dispersed particles. “Stably dispersed” means that the particles do not settle or cream during storage at room temperature over a period of at least one week.

“Low temperatures” or “temperatures which are lower than the temperatures customarily used,” as used herein in conjunction with dishwashing methods, preferably refers to temperatures below 60° C., in particular below 55° C., more preferably 50° C. or lower, particularly preferably 45° C. or lower, and most preferably 40° C. or lower. These temperature indications refer to the target temperatures used in the cleaning steps.

These and further aspects, features, and advantages of the disclosure are apparent to those skilled in the art from a study of the following detailed description and claims. Any feature of one aspect of the disclosure may be used in any other aspect of the disclosure. In addition, it is self-evident that the examples contained herein describe and illustrate the disclosure, but do not limit the disclosure, and in particular do not limit the disclosure to these examples. Unless stated otherwise, all percentage indications are % by weight. Numerical ranges expressed in the format “from x to y” include the stated values. When multiple preferred numerical ranges are expressed in this format, it is self-evident that all ranges that result from the combination of the various end points are likewise encompassed.

In various embodiments of the disclosure, the cleaning agent includes at least one first amylase and/or at least one second amylase, wherein
(A) the first amylase is comprised in the solid enzyme formulation; and
(B) the second amylase is comprised in the liquid enzyme formulation.

The amylases used are in particular alkaline α-amylases. These amylases act as hydrolases and cleave the α(1-4)-glycoside bond of polysaccharides, in particular starches such as amylose, and thus bring about degradation of starch-containing soils on the item being cleaned. Dextrins, from which maltose, glucose, and branched oligosaccharides are formed, arise as cleavage products. Their optimum pH is usually in the strongly alkaline range.

In various embodiments of the disclosure, the first amylase is an α-amylase of Bacillus sp. No. 707 or a functional fragment or a variant thereof. In various further embodiments, the second amylase is an AA560 α-amylase of Bacillus sp. or a functional fragment or a variant thereof.

The wild type sequences of the mature α-amylase of Bacillus sp. No. 707 or the mature AA560 α-amylase of Bacillus sp. are stated in SEQ ID NO:1 or SEQ ID NO:2, respectively.

“Different,” as used herein with regard to the enzymes, refers to enzymes which differ in their amino acid sequence. In various embodiments, enzymes which are different from one another originate from different types of organisms, or differ from one another by mutations, for example artificially produced mutations.

“Variant,” as used herein with regard to enzymes, refers to natural or artificially produced variations of a native enzyme which have a modified amino acid sequence compared to the reference form. Such a variant may have single or multiple point mutations, i.e., substitutions of a naturally occurring amino acid at the position in question by another, insertions (addition of one or more amino acids), and/or deletions (removal of one or more amino acids), in particular one or more point mutations. Such variants preferably have at least 50, preferably 60 or more, more preferably 70, 80, 90, 100%, or more, of the enzyme activity of the reference form. In various embodiments, such a variant has an amino acid sequence that is at least 70%, preferably 75%, 80%, 85%, 90%, 95%, 96%, 97%, 98%, or 99%, identical over its entire length to the sequence being used as a reference. The variants preferably have the same length as the reference sequence. Variants may be characterized by improved properties compared to the reference form, such as higher enzyme activity, greater stability, altered substrate specificity, etc. Only variants which have enzymatic activity are used. “Enzymatic activity,” as used in this context, means in particular that the enzymes in question have at least 50%, preferably at least 90%, of the catalytic activity of their reference enzyme.

“Fragment,” as used herein in conjunction with enzymes, refers to polypeptides which are shorter at the N-terminus and/or C-terminus by one or more amino acids in each case compared to the reference enzyme. Only fragments which have enzymatic activity are used. “Enzymatic activity,” as used in this context, means in particular that the enzymes in question have at least 50%, preferably at least 90%, of the catalytic activity of their reference enzyme.

The identity of nucleic acid or amino acid sequences is determined by a sequence comparison. This sequence comparison is based on the BLAST algorithm, which is established in the prior art and customarily used (see, for example, Altschul, S. F., Gish, W., Miller, W., Myers, E. W. & Lipman, D. J. (1990): “Basic local alignment search tool,” J. Mol. Biol. 215:403-410, and Altschul, Stephan F., Thomas L. Madden, Alejandro A. Schaffer, Jinghui Zhang, Hheng Zhang, Webb Miller, and David J. Lipman (1997): “Gapped BLAST and PSI-BLAST: a new generation of protein database search programs”; Nucleic Acids Res., 25, pp. 3389-3402), and in principle is carried out by associating similar series of nucleotides or amino acids in the nucleic acid or amino acid sequences with one another. A tabular association of the positions in question is referred to as an alignment. Another algorithm available in the prior art is the FASTA algorithm.

Such a comparison also allows a conclusion to be drawn concerning the similarity of the compared sequences to one another. The similarity is usually expressed in percent identity, i.e., the proportion of the identical nucleotides or amino acid moieties at the same positions or at positions corresponding to one another in an alignment. The broad concept of homology takes into consideration amino acid exchanges that are preserved in amino acid sequences, i.e., amino acids having similar chemical activity, since these amino acids usually carry out similar chemical activities within the protein. Therefore, the similarity of the compared sequences may also be expressed in percent homology or percent similarity. Identity and/or homology indications may be provided over entire polypeptides or genes, or only over individual regions. Homologous or identical regions of different nucleic acid or amino acid sequences are therefore defined by matches in the sequences. Such regions often have identical functions. They may be small, and may include only a few nucleotides or amino acids. Such small regions often carry out functions that are essential for the overall activity of the protein. It may therefore be meaningful to base sequence matches only on individual, optionally small regions. Unless stated otherwise, however, identity and/or homology indications in the present patent application refer to the overall length of the particular stated nucleic acid or amino acid sequence.

As the first amylase within the meaning of the present disclosure, in various preferred embodiments an amylase is used which comprises an amino acid sequence which is at least 80% identical over its entire length to the amino acid sequence stated in SEQ ID NO:1, and which optionally has at least one amino acid substitution at one of the positions 172, 202, 208, 255, and 261 in the count according to SEQ ID NO:1, in particular selected from the group comprising M202L, M202V, M2025, M202T, M202I, M202Q, M202W, S255N, and R172Q.

Thus, in preferred embodiments of the disclosure, as the first amylase a variant of the α-amylase of Bacillus sp. No. 707 having the amino acid sequence stated in SEQ ID NO:1 is used which is at least 80% identical over its entire length to the amino acid sequence stated in SEQ ID NO:1, and which has at least one amino acid substitution at one of the positions 172, 202, 208, 255, and 261 in the count according to SEQ ID NO:1. Amylases are preferably used which have an amino acid substitution at two, preferably three, of the above-mentioned positions, in particular a substitution at position 202 selected from M202L, M202V, M2025, M202T, M202I, M202Q, M202W, a substitution at position 255, in particular S255N, and a substitution at position 172, in particular R172Q. The M202L and M202T mutants are very particularly preferred.

Further variants which may be used are those having an amino acid sequence which is at least 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% identical to the amino acid sequence stated in SEQ ID NO:1, the positions 172, 202, and 255 preferably being substituted as described above. Such variants may include, for example, a shortening of the C-terminus, for example by 1-20 amino acids, or a deletion of one or more amino acids, in particular at the positions 181, 182, 183, and 184 in the count according to SEQ ID NO:1, but while maintaining the enzymatic activity; i.e., the activity of the variant is at least 60% of the activity of the enzyme having the amino acid sequence of SEQ ID NO:1. Suitable amylases are also described in WO 2008/112459 A2, the entire disclosure of which is incorporated herein by reference.

The second amylase is different from the first amylase, i.e., is an amylase which falls under the definition of the first amylase as well as of the second amylase, and cannot be simultaneously counted both as a first amylase and as a second amylase.

In various embodiments of the disclosure, the second amylase comprises an amino acid sequence which is at least 80% identical to the amino acid sequence stated in SEQ ID NO:2, and which optionally has at least one amino acid substitution at one of the positions 9, 26, 30, 33, 82, 37, 106, 118, 128, 133, 149, 150, 160, 178, 182, 186, 193, 195, 202, 203, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, and 484 and/or one of the deletions D183* and G184* in the count according to SEQ ID NO:2.

In various preferred embodiments, the second amylase in the count according to SEQ ID NO:2 has amino acid substitutions at three or more of the positions 9, 26, 149, 182, 186, 202, 257, 295, 299, 323, 339, and 345, and optionally has one or more, preferably all, of the substitutions and/or deletions at the positions 118, 183, 184, 195, 320, and 458, particularly preferably R118K, D183*, G184*, N195F, R320K, and/or R458K.

In particularly preferred embodiments, the second amylase in the count according to SEQ ID NO:2 has the following amino acid substitutions and/or deletions:
(i) M9L+M323T;
(ii) M9L+M202L/T/V/I+M323T;
(iii) M9L+N195F+M202L/T/V/I+M323T;
(iv) M9L+R118K+D183*+G184*+R320K+M323T+R458K;
(v) M9L+R118K+D183*+G184*+M202L/T/V/I+R320K+M323T+R458K;
(vi) M9L+G149A+G182T+G186A+M202L+T257I+Y295F+N299Y+M323T+A339S+E345R;
(vii) M9L+G149A+G182T+G186A+M202I+T257I+Y295F+N299Y+M323T+A339S+E345R;
(viii) M9L+R118K+G149A+G182T+D183*+G184*+G186A+M202L+T257I+Y295F+N299Y+R320K+M323T+A339S+E345R+R458K;
(ix) M9L+R118K+G149A+G182T+D183*+G184*+G186A+N195F+M202L+T257I+Y295F+N299Y+R320K+M323T+A339S+E345R+R458K;
(x) M9L+R118K+G149A+G182T+D183*+G184*+G186A+M202I+T257I+Y295F+N299Y+R320K+M323T+A339S+E345R+R458K;
(xi) M9L+R118K+D183*+D184*+N195F+M202L+R320K+M323T+R458K;
(xii) M9L+R118K+D183*+D184*+N195F+M202T+R320K+M323T+R458K;
(xiii) M9L+R118K+D183*+D184*+N195F+M202I+R320K+M323T+R458K;
(xiv) M9L+R118K+D183*+D184*+N195F+M202V+R320K+M323T+R458K;
(xv) M9L+R118K+N150H+D183*+D184*+N195F+M202L+V214T+R320K+M323T+R458K; or
(xvi) M9L+R118K+D183*+D184*+N195F+M202L+V214T+R320K+M323T+E345N+R458K.

A particularly preferred second amylase is the variant that is commercially available under the trade name Stainzyme Plus™ (Novozymes A/S, Bagsværd, Denmark).

Preferred within the scope of the present disclosure are combinations of a first amylase which is at least 80% identical over its entire length to the amino acid sequence stated in SEQ ID NO:1, and which has at least one amino acid substitution at one of the positions 172, 202, 208, 255, and 261 in the count according to SEQ ID NO:1, in particular a substitution at position 202 selected from M202L, M202V, M2025, M202T, M202I, M202Q, M202W, a substitution at position 255, in particular S255N, and a substitution at position 172, in particular R172Q, and a second amylase which is at least 80% identical over its entire length to the amino acid sequence stated in SEQ ID NO:2 and which has the following amino acid substitutions and/or deletions:
(i) M9L+M323T;
(ii) M9L+M202L/T/V/I+M323T;
(iii) M9L+N195F+M202L/T/V/I+M323T;
(iv) M9L+R118K+D183*+G184*+R320K+M323T+R458K;
(v) M9L+R118K+D183*+G184*+M202L/T/V/I+R320K+M323T+R458K;
(vi) M9L+G149A+G182T+G186A+M202L+T257I+Y295F+N299Y+M323T+A339S+E345R;
(vii) M9L+G149A+G182T+G186A+M202I+T257I+Y295F+N299Y+M323T+A339S+E345R;
(viii) M9L+R118K+G149A+G182T+D183*+G184*+G186A+M202L+T257I+Y295F+N299Y+R320K+M323T+A339S+E345R+R458K;
(ix) M9L+R118K+G149A+G182T+D183*+G184*+G186A+N195F+M202L+T257I+Y295F+N299Y+R320K+M323T+A339S+E345R+R458K;
(x) M9L+R118K+G149A+G182T+D183*+G184*+G186A+M202I+T257I+Y295F+N299Y+R320K+M323T+A339S+E345R+R458K;
(xi) M9L+R118K+D183*+D184*+N195F+M202L+R320K+M323T+R458K;
(xii) M9L+R118K+D183*+0184*+N195F+M202T+R320K+M323T+R458K;
(xiii) M9L+R118K+D183*+D184*+N195F+M202I+R320K+M323T+R458K;
(xiv) M9L+R118K+D183*+D184*+N195F+M202V+R320K+M323T+R458K;
(xv) M9L+R118K+N150H+D183*+D184*+N195F+M202L+V214T+R320K+M323T+R458K; or
(xvi) M9L+R118K+D183*+D184*+N195F+M202L+V214T+R320K+M323T+E345N+R458K.

In various embodiments, these combinations of amylases are used in a mass ratio of about 10:1 to about 1:10, preferably about 5:1 to about 1:5, in particular about 2:1 to about 1:2, for example about 2:3 to about 3:2, particularly preferably in equal parts, based on active protein.

In preferred embodiments, the cleaning agents described may contain at least one first protease and at least one second protease, wherein
(A) the first protease is contained in the solid enzyme formulation; and
(B) the second protease is contained in the liquid enzyme formulation.

The cleaning agents may contain these proteases either alone, or preferably in combination with the amylases described above. The various enzymes may be formulated in each case separately in a liquid or solid formulation, or in each case together in a solid or a liquid formulation (i.e., the first amylase and first protease in a shared solid formulation and/or the second amylase and second protease in a shared liquid formulation).

It may be preferred to formulate the first protease in the solid enzyme formulation and the second amylase in the liquid enzyme formulation.

It may likewise be preferred to formulate the first amylase in the solid enzyme formulation and the second protease in the liquid enzyme formulation.

Preferred combinations contain, in the liquid phase and also in the solid phase, a corresponding amylase in each case, and in one of the two phases then contain a corresponding protease either in the liquid phase or in the solid phase.

It may likewise be preferred for the liquid phase and the solid phase to each contain a corresponding amylase and a corresponding protease.

The proteases are in particular alkaline serin proteases. They act as nonspecific endopeptidases; i.e., they hydrolyze arbitrary acid amine bonds present inside peptides or proteins, and thus bring about the degradation of protein-containing soils on the item being cleaned. Their optimum pH is usually in the strongly alkaline range.

In various embodiments of the disclosure, the at least one first protease includes a protease of Bacillus alcalophilus PB92 or a functional fragment or a variant thereof. The sequence of the mature protease of Bacillus alcalophilus PB92 (wild type) is stated in SEQ ID NO:4. In preferred embodiments, this first protease may have an amino acid sequence which is at least 80%, preferably at least 90%, in particular 100%, identical over its entire length to the amino acid sequence stated in SEQ ID NO:4, and which optionally has at least one amino acid substitution at one of the following positions: 32, 33, 48-54, 58-62, 94-107, 116, 123-133, 150, 152-156, 158-161, 164, 169, 175-186, 197, 198, 203-216 in the count according to SEQ ID NO:4.

Further variants which may be used are those having an amino acid sequence which is at least 80%, and increasingly preferably, at least 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, or 99% identical to the amino acid sequence stated in SEQ ID NO:4, and which in the count according to SEQ ID NO:4 bears an amino acid substitution at at least one of the following positions: 32, 33, 48-54, 58-62, 94-107, 116, 123-133, 150, 152-156, 158-161, 164, 169, 175-186, 197, 198, 203-216.

A variant of the protease having the amino acid sequence stated in SEQ ID NO:4 may preferably be used which is at least 80% identical over its entire length to the amino acid sequence stated in SEQ ID NO:4, and which has at least one amino acid substitution at one of the positions 116, 126, 127, 128, and 160 in the count according to SEQ ID NO:4. Proteases are preferably used which have an amino acid substitution at two, preferably three or more, in particular four, of the above-mentioned positions.

Further variants which may be used are those having an amino acid sequence which is at least 81%, 82%, 83%, 84%, 85%, 86%, 87%, 88%, 89%, 90%, 91%, 92%, 93%, 94%, 95%, 96%, 97%, 98%, or 99% identical to the amino acid sequence stated in SEQ ID NO:4, and which has at least one amino acid substitution at one of the following positions: 116, 126, 127, 128, and 160.

Such a protease particularly preferably has an amino acid sequence which is at least 80% identical over its entire length to the amino acid sequence stated in SEQ ID NO:4, and which in the count according to SEQ ID NO:4 has one of the following combinations of amino acid substitutions:
(i) G116V+S126L+P127Q+S128A
(ii) G116V+S126N+P127S+S128A+S160D
(iii) G116V+S126L+P127Q+S128A+S160D
(iv) G116V+S126V+P127E+S128K
(v) G116V+S126V+P127M+A160D
(vi) S128T
(vii) G116V+S126F+P127L+S128T
(viii) G116V+S126L+P127N+S128V
(ix) G116V+S126F+P127Q
(x) G116V+S126V+P127E+S128K+S160D
(xi) G116V+S126R+P127S+S128P
(xii) S126R+P127Q+S128D
(xiii) S126C+P127R+S128D; or
(xiv) S126C+P127R+S128G.

Such a protease preferably has an amino acid sequence which in the count according to SEQ ID NO:4 has at least one, preferably multiple, in particular each, of the following amino acid substitutions: G116V, S126L, P127Q, and/or S128A, and at all other locations is at least 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, or 99%, in particular 100%, identical over its entire length to the amino acid sequence stated in SEQ ID NO:4. Particularly preferred is a protease having an amino acid sequence which, starting from the amino acid sequence with SEQ ID NO:4, is obtainable by the amino acid substitutions G116V, S126L, P127Q, and S128A in the count according to SEQ ID NO:4. Such a protease may have the amino acid sequence stated in SEQ ID NO:8.

The at least one second protease is preferably selected from the group comprising a subtilisin 309 of Bacillus lentus or a functional fragment or a variant thereof, and an alkaline protease of Bacillus lentus DSM 5483 or a functional fragment or a variant thereof. Combinations of several of the above-mentioned enzymes may likewise be used.

The sequences of the mature protease subtilisin 309 of Bacillus lentus and of the mature alkaline protease of Bacillus lentus DSM 5483 are stated in SEQ ID NO:3 and SEQ ID NO:5, respectively.

In various embodiments of the disclosure, the second protease includes a subtilisin 309 of Bacillus lentus or a functional fragment or a variant thereof, having an amino acid sequence which is at least 80%, preferably at least 90%, in particular 100%, identical over its entire length to the amino acid sequence stated in SEQ ID NO:3, and which has at least one amino acid substitution at one of the positions 9, 15, 66, 212, and 239 in the count according to SEQ ID NO:3. Those having an amino acid substitution at two, preferably three, in particular four, very particularly preferably five, of the above-mentioned positions are preferred.

Further variants which may be used are those having an amino acid sequence which is at least 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% identical to the amino acid sequence stated in SEQ ID NO:3, wherein one or more of the positions 9, 15, 66, 212, and 239 is/are substituted; i.e., the amino acid at these positions does not correspond to the corresponding amino acid in SEQ ID NO:3.

A variant is particularly preferably used which has at least one, preferably two, in particular three, particularly preferably four, or very particularly preferably five, of the amino acid substitutions selected from S9R, A15T, V66A, N212D, and Q239R based on the count according to SEQ ID NO:3. The following combinations are preferred:

S9R+V66A+N212D+Q239R, S9R+A15T+N212D+Q239R, S9R+A15T+V66A+Q239R, S9R+A15T+V66A+N212D, A15T+V66A+N212D+Q239R; S9R+A15T+V66A, S9R+A15T+N212D, S9R+A15T+Q239R, S9R+N212D+Q239R, S9R+V66A+N212D, S9R+V66A+Q239R, A15T+V66A+N212D, A15T+V66A+Q239R, A15T+N212D+Q239R, V66A+N212D+Q239R; S9R+A15T, S9R+V66A, S9R+N212D, S9R+Q239R, A15T+V66A, A15T+N212D, A15T+Q239R, V66A+N212D, V66A+Q239R, N212D+Q239R. A variant which includes all the above-mentioned alterations has the amino acid sequence stated in SEQ ID NO:6 (S9R+A15T+V66A+N212D+Q239R).

Likewise, preferably preferred are variants of protease having the amino acid sequence stated in SEQ ID NO:3, which have an amino acid substitution at position 99 and an insertion of an amino acid between the amino acids at positions 99 and 100 in the count according to SEQ ID NO:3, preferably selected from S99A and/or S99_G100InsD. Further variants which may be used are those having an amino acid sequence which is at least 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, or 99% identical to the amino acid sequence stated in SEQ ID NO:3, wherein these variants have one or both of the above-mentioned mutations at positions 99 and 100. Variants having both mutations are preferred. Such a variant has the amino acid sequence stated in SEQ ID NO:7.

In yet further various embodiments of the disclosure, the second protease includes an alkaline protease of Bacillus lentus DSM 5483 or a functional fragment or a variant thereof, having an amino acid sequence which is at least 80%, preferably at least 90%, in particular 100%, identical over its entire length to the amino acid sequence stated in SEQ ID NO:5, and which optionally has at least one amino acid substitution at one, two, three, or four of the following positions: 3, 4, 99, and 199 in the count according to SEQ ID NO:5. Proteases are preferably used which have an amino acid substitution at two, preferably three or more, in particular four, of the above-mentioned positions.

Further variants which may be used are those having an amino acid sequence which is at least 81%, 82%, 83%, 84%, 85%, 86%, 87%, 88%, 89%, 90%, 91%, 92%, 93%, 94%, 95%, 96%, 97%, 98%, or 99% identical to the amino acid sequence stated in SEQ ID NO:5, and which have at least one amino acid substitution at one of the following positions: 3, 4, 99, and 199.

Such a protease particularly preferably has an amino acid sequence which is at least 80% identical over its entire length to the amino acid sequence stated in SEQ ID NO:5, and which in the count according to SEQ ID NO:5 has the amino acid substitution R99E or R99D, and optionally additionally at least one or two, preferably all three, of the amino acid substitutions S3T, V41, and V1991.

Such a protease preferably has an amino acid sequence which in the count according to SEQ ID NO:5 has at least one, preferably multiple, in particular each, of the following amino acid substitutions: R99E/R99D, S3T, V41, and/or V1991, and at all other locations is at least 80%, 81%, 82%, 83%, 84%, 85%, 86%, 87%, 88%, 89%, 90%, 90.5%, 91%, 91.5%, 92%, 92.5%, 93%, 93.5%, 94%, 94.5%, 95%, 95.5%, 96%, 96.5%, 97%, 97.5%, 98%, 98.5%, or 99%, in particular 100%, identical over its entire length to the amino acid sequence stated in SEQ ID NO:5. A protease is particularly preferred which has an amino acid sequence, starting from the amino acid sequence with SEQ ID NO:5, which is obtainable by one or more of the amino acid substitutions R99E/R99D, S3T, V41, and V1991 in the count according to SEQ ID NO:5. Such a protease may have the amino acid sequence stated in one of SEQ ID Nos:9-10.

It is particularly preferred as contemplated herein to use a combination of a first protease and a second protease. A first protease having an amino acid sequence which, starting from the amino acid sequence with SEQ ID NO:4, is obtainable by the amino acid substitutions G116V, S126L, P127Q, and S128A in the count according to SEQ ID NO:4 is particularly preferred. Such a protease may have the amino acid sequence stated in SEQ ID NO:8. In particular, a variant of the protease having the amino acid sequence according to SEQ ID NO:9 is used as the second protease.

In various embodiments, these combinations of two proteases are used in a mass ratio of 10:1 to 1:10, preferably 5:1 to 1:5, in particular 2:1 to 1:2, for example 2:3 to 3:2, particularly preferably in equal parts, based on active protein.

The cleaning agents of the disclosure may contain the solid enzyme formulation in a quantity of 0.01 to 5% by weight, preferably 0.2 to 2% by weight, based on the total weight of the cleaning agent. The solid enzyme formulation may in particular have an active enzyme content of 2 to 20% by weight.

The liquid enzyme formulation may be contained in the cleaning agents in a quantity of about 0.01 to about 8% by weight, preferably about 0.3 to about 6% by weight, based on the total weight of the cleaning agent. The liquid enzyme formulation may in particular have an active enzyme content of about 1 to about 6% by weight.

The protein concentration may be determined using known methods, for example the BCA method (bicinchoninic acid; 2,2′-bichinolyl-4,4′-dicarboxylic acid) or the biuret method. In this regard, the active protein concentration is determined by titration of the active centers, using a suitable irreversible inhibitor (for proteases, for example phenylmethylsulfonyl fluoride (PMSF)) and determining the residual activity (see M. Bender et al., J. Am. Chem. Soc. 88, 24 (1966), pp. 5890-5913).

In general, the cleaning agent may contain the liquid enzyme formulation and the solid enzyme formulation in a mass ratio of about 10:1 to about 1:10, preferably 1:1.

The combinations of liquid- and solid-formulated amylases or proteases described herein surprisingly exhibit the property that the performance of the cleaning agent, preferably the dishwasher detergent, is improved in that it results in improved cleaning power on enzyme-sensitive soils.

The improvement in the cleaning power is generally understood to mean that when the cleaning agents, in particular the dishwasher detergents, described herein are used, the removal of soils on hard surfaces, in particular dishes, is noticeably improved during their cleaning, preferably in an automatic dishwasher, compared to the use of cleaning agents, preferably dishwasher detergents, which do not contain the enzyme combinations described herein.

The enzymes to be used in the particular formulations are additionally provided with accompanying substances, for example from fermentation, or with stabilizers.

The enzymes may be protected, in particular during storage, from damage such as inactivation, denaturing, or destruction due to physical influences, oxidation, or proteolytic cleavage, for example. Inhibition of proteolysis is particularly preferred in microbial harvesting. The described agents may contain stabilizers for this purpose. Cleaning-active enzymes are typically already provided in the form of stabilized preparations which are storable and transportable. These preprovided preparations include, for example, the solid preparations obtained by granulation, extrusion, or lyophilization, or, in particular for liquid or gel-form agents, solutions of the enzymes which are advantageously preferably concentrated, low-water, and/or combined with stabilizers or further auxiliary agents.

Alternatively, the enzymes may be encapsulated for the solid as well as the liquid administration form, for example by spray drying or extrusion of the enzyme solution together with a preferably natural polymer or in the form of capsules, for example those in which the enzymes are enclosed, such as in a solidified gel, or in those of the core-shell type, in which an enzyme-containing core is coated with a protective layer that is impermeable to water, air, or chemicals. In addition, further active substances, for example stabilizers, emulsifiers, pigments, whitening substances, or dyes may be applied in superimposed layers. Capsules of this type are provided according to methods known per se, for example by shaking granulation or rolling granulation, or in fluid bed processes. Such granulates advantageously generate little dust, for example due to application of polymeric film-forming agents, and on account of the coating are stable during storage.

Moreover, it is possible to provide two or more enzymes together, so that an individual granulate has multiple enzyme activities.

As is apparent from the preceding discussion, the enzyme protein forms only a fraction of the total weight of customary enzyme preparations. Typically used enzyme preparations contain between about 0.1 and about 40% by weight, preferably between about 0.2 and about 30% by weight, particularly preferably between about 0.4 and about 20% by weight, and in particular between about 0.8 and about 15% by weight, of the enzyme protein.

In various embodiments of the disclosure, the solid enzyme preparation is a granulate. The granulate particles may be colored or may have light-reflecting properties. The particles typically have an average particle size (sieve analysis) in the range of about 1 μm to about 700 μm.

Preferred liquid agents have densities of about 0.5 to about 2.0 g/cm³, in particular about 0.7 to about 1.7 g/cm³, in particular about 1.0 to about 1.5 g/cm³. The difference in densities between the granulates and the liquid phase of the agent is preferably not more than 10% of the density of one of the two, and in particular is small enough that the granulates as contemplated herein, and preferably also other solid particles possibly contained in the agents, are suspended in the liquid phase.

In various embodiments, the liquid enzyme preparation is a solution, in particular an aqueous solution.

The cleaning agents described herein are (homogeneous) solutions in which the solid enzyme formulations are stably suspended and in which the liquid enzyme preparations are preferably dissolved.

In one preferred embodiment of the disclosure, the cleaning agent, in particular the machine dishwasher detergent, is present in a preportioned form. In one embodiment of the disclosure, the cleaning agent contains multiple compositions that are spatially separate from one another, thus making it possible to separate incompatible ingredients from one another, or to provide compositions in combination which are used at different times in the dishwasher. This is particularly advantageous when the machine dishwasher detergents are present in preportioned form.

The cleaning agents of the disclosure are preferably liquid, low-water compositions. The cleaning agents as contemplated herein are preferably dishwashing detergents, in particular machine dishwasher detergents.

The term “low-water” as used herein means that the composition characterized in this way contains less than 25% by weight water, preferably less than 20% by weight water. In particular, compositions containing about 1 to about 20% by weight water, about 1 to about 15% by weight water, about 5 to about 15% by weight water, or 1 about 0% to less than 20% by weight water fall under this term.

The water content as defined herein refers to the water content as determined by Karl Fischer titration.

“Liquid,” as used herein with regard to the cleaning agent as contemplated herein, includes all flowable compositions, and in particular also encompasses gels and paste-like compositions.

“At least one” as used herein means 1 or more, for example 1, 2, 3, 4, 5, or more.

In various embodiments, the cleaning agent contains at least one polyhydric alcohol, in particular selected from glycerin and mixtures of glycerin and 1,2-propylene glycol. The polyhydric alcohols allow incorporation of other components into the cleaning agent formulation, even for a small quantity of water, in particular when the quantity of water is limited to 20% by weight.

The total quantity of polyhydric alcohol or alcohol mixtures used in cleaning agents as contemplated herein is preferably at least 20% by weight, in particular at least 25% by weight, particularly preferably at least 28% by weight, most preferably at least 30% by weight. Preferred quantity ranges are about 20 to about 50% by weight, in particular about 25 to about 45% by weight, most preferably about 28 to about 40% by weight.

The polyhydric alcohol is preferably selected from glycerin, sorbitol, and mixtures of glycerin and/or sorbitol with 1,2-propylene glycol. Glycerin is preferably used in agents as contemplated herein in a quantity of about 1 to about 50% by weight, in particular in a quantity of about 10 to about 45% by weight, particularly preferably in a quantity of about 20 to about 40% by weight. Sorbitol is preferably used in agents as contemplated herein in a quantity of about 1 to about 50% by weight, in particular in a quantity of about 10 to about 45% by weight, particularly preferably in a quantity of about 20 to about 40% by weight.

Alternatively, a mixture of glycerin and 1,2-propylene glycol may be used. The glycerin is preferably used in a quantity of about 0.1 to about 50% by weight, in particular in a quantity of about 15 to about 45% by weight, particularly preferably in a quantity of about 20 to about 40% by weight. The 1,2-propylene glycol is preferably used in a quantity of about 1 to about 20% by weight, in particular in a quantity of about 5 to about 15% by weight, particularly preferably in a quantity of about 8 to about 12% by weight, in each case based on the total mass of the cleaning agent, wherein the total quantity of glycerin and 1,2-propylene glycol is preferably at least 20% by weight, in particular at least 25% by weight, particularly preferably at least 30% by weight, very particularly preferably about 25 to about 45% by weight, in particular about 30 to about 42% by weight, most preferably about 35 to about 40% by weight, in each case based on the total mass of the cleaning agent.

Alternatively, a mixture of sorbitol and 1,2-propylene glycol may be used. The sorbitol is preferably used in a quantity of about 0.1 to about 50% by weight, in particular in a quantity of about 15 to about 45% by weight, particularly preferably in a quantity of about 20 to about 40% by weight. The 1,2-propylene glycol is preferably used in a quantity of about 1 to about 20% by weight, in particular in a quantity of about 5 to about 15% by weight, particularly preferably in a quantity of about 8 to about 12% by weight, in each case based on the total mass of the cleaning agent, wherein the total quantity of sorbitol and 1,2-propylene glycol is preferably at least 20% by weight, in particular at least 25% by weight, particularly preferably at least 30% by weight, very particularly preferably about 25 to about 45% by weight, in particular about 30 to about 42% by weight, most preferably about 35 to about 40% by weight, in each case based on the total mass of the cleaning agent.

In various embodiments of the disclosure, the cleaning agents are characterized in that the mass ratio of glycerin to 1,2-propylene glycol is greater than 2:1.

The cleaning agent may also be a phosphate-containing cleaning agent, in particular a phosphate-containing machine dishwasher detergent. The phosphates are preferably contained in the form of polyphosphates. Examples of polyphosphates that are usable as contemplated herein include tripolyphosphates, pyrophosphates, and metaphosphates, in particular the sodium or potassium salts thereof. Tripolyphosphates are preferably used.

The tripolyphosphates (or also triphosphates) which are usable as contemplated herein are condensation products of ortho-phosphoric acid (H₃PO₄) having the empirical formula P₃O₁₀⁵⁻, which are usually used in the form of their salts, preferably of the alkali metal or alkaline earth metal, more preferably in the form of their alkali metal salts. Tripolyphosphate salts are generally hygroscopic, white, odorless, incombustible solids that are readily soluble in water. In particular the potassium salt of tripolyphosphate (K₅P₃O₁₀) or a mixture of the potassium salt of the tripolyphosphate and the sodium salt of tripolyphosphate (Na₅P₃O₁₀) are used as contemplated herein. It is most preferred to use only the potassium salt of tripolyphosphate.

The weight percentage of the polyphosphates, in particular of the tripolyphosphate, in the total weight of the cleaning agent as contemplated herein is preferably about 0.1 to about 30% by weight, in particular about 1 to about 28% by weight, particularly preferably about 5 to about 25% by weight, more preferably about 10 to about 23% by weight.

The cleaning agents may preferably contain one or more nonphosphate-containing builder(s) (builders/co-builders) (optionally in addition to or also instead of the at least one phosphate-containing builder component). The weight percentage of this at least one nonphosphate-containing builder component, in addition to the one phosphate-containing builder component, in the total weight of the agents as contemplated herein is preferably about 0.1 to about 10% by weight, and in particular about 2 to about 7% by weight.

The weight percentage of this at least one nonphosphate-containing builder component of various builders in the total weight of the agents as contemplated herein is preferably about 0.1 to about 60% by weight, and in particular about 2 to about 45% by weight.

These nonphosphate-containing builder components/builders include in particular carbonates, citrates, phosphonates, methylglycinediacetic acid (MGDA) or the salts thereof, glutamic acid N,N-diacetic acid (GLDA) or the salts thereof, ethylenediamine-N,N′-disuccinic acid (EDDS) or the salts thereof, organic co-builders, and silicates.

It is also possible to use, for example, carbonate(s) and/or hydrogen carbonate(s), preferably alkali carbonate(s), particularly preferably sodium carbonate.

Mentioned as organic co-builders are in particular polycarboxylates/polycarboxylic acids, polymeric carboxylates, aspartic acid, polyacetals, dextrins, and organic co-builders. These substance classes are described below.

Examples of organic builder substances that may be used include the polycarboxylic acids, which are usable in the form of the free acid and/or the sodium salts thereof, wherein polycarboxylic acids are understood to mean those carboxylic acids bearing more than one acid function. These include, for example, citric acid, adipic acid, succinic acid, glutaric acid, malic acid, tartaric acid, maleic acid, fumaric acid, sugar acids, aminocarboxylic acids, and nitrilotriacetic acid (NTA), provided that such use is not objectionable for environmental reasons, and mixtures thereof. The free acids, in addition to their builder effect, typically also have the property of an acidification component, and are thus also used for setting a lower, milder pH of cleaning agents. Mentioned in particular are citric acid, succinic acid, glutaric acid, adipic acid, gluconic acid, and any given mixtures thereof.

Particularly preferred cleaning agents contain citrate, for example sodium citrate or potassium citrate, as one of their important nonphosphate-containing builder components. Cleaning agents containing about 1 to about 10% by weight, preferably about 2 to about 5% by weight, citrate are preferred as contemplated herein.

Also suitable as builders are polymeric polycarboxylates, for example the alkali metal salts of polyacrylic acid or of polymethacrylic acid, for example those having a relative molecular mass of about 500 to about 70,000 g/mol.

Suitable polymers are in particular polyacrylates which preferably have a molecular mass of about 2000 to about 20,000 g/mol. Due to their excellent solubility, the short-chain polyacrylates having molar masses of 2000 to about 10,000 g/mol, particularly preferably about 3000 to 5 about 000 g/mol, may be preferred from this group.

The cleaning agents may in particular also contain phosphonates as builder. A hydroxyalkane phosphonate and/or aminoalkane phosphonate is preferably used as the phosphonate compound. Among the hydroxyalkane phosphonates, 1-hydroxyethane-1,1-diphosphonate (HEDP) is of particular importance. Preferably ethylenediaminetetramethylene phosphonate (EDTMP), diethylenetriaminepentamethylene phosphonate (DTPMP), and the higher homologs thereof are suitable as aminoalkane phosphonates. Phosphonates are preferably contained in the agents in quantities of about 0.1 to about 10% by weight, in particular in quantities of about 0.5 to about 8% by weight, in each case based on the total weight of the cleaning agent.

The cleaning agents may also contain, as a further builder component, crystalline phyllosilicates of the general formula NaMSiₓO₂ₓ₊₁.y H₂O, where M represents sodium or hydrogen, x is a number from 1.9 to 22, preferably from 1.9 to 4, with values 2, 3, or 4 for x being particularly preferred, and y is a number from 0 to 33, preferably from 0 to 20. Amorphous sodium silicates having an Na₂O:SiO₂ modulus of 1:2 to 1:3.3, preferably 1:2 to 1:2.8, and in particular 1:2 to 1:2.6, and which preferably have a delayed-release design and have secondary wash properties, are also usable.

In preferred cleaning agents, the content of silicates, based on the total weight of the cleaning agent, is limited to quantities below 10% by weight, preferably below 5% by weight, and in particular below 2% by weight. Particularly preferred cleaning agents are silicate-free.

The cleaning agents as contemplated herein may also contain a sulfopolymer. The weight percentage of the sulfopolymer in the total weight of the cleaning agent as contemplated herein is preferably about 0.1 to about 20% by weight, in particular about 0.5 to about 18% by weight, particularly preferably about 1.0 to about 15% by weight, in particular about 4 to about 14% by weight, most preferably about 6 to about 12% by weight. The sulfopolymer is usually used in the form of an aqueous solution, wherein the aqueous solutions typically contain about 20 to about 70% by weight, in particular about 30 to about 50% by weight, preferably approximately about 35 to about 40% by weight, of sulfopolymer(s).

A copolymeric polysulfonate, preferably a hydrophobically modified copolymeric polysulfonate, is preferably used as sulfopolymer.

The copolymers may comprise two, three, four, or more different monomer units.

Preferred copolymeric polysulfonates contain, in addition to sulfonic acid group-containing monomer(s), at least one monomer from the group of unsaturated carboxylic acids.

Unsaturated carboxylic acids of formula R¹(R²)C═C(R³)COOH are particularly preferably used as unsaturated carboxylic acid(s), in which R¹ to R³ independently stand for —H, —CH₃, a straight-chain or branched saturated alkyl moiety containing 2 to 12 carbon atoms, a straight-chain or branched, singly or multiply unsaturated alkenyl moiety containing 2 to 12 carbon atoms, alkyl or alkenyl moieties as defined above substituted with —NH₂, —OH, or —COOH, or for —COOH or —COOR⁴, where R⁴ is a saturated or unsaturated, straight-chain or branched hydrocarbon moiety containing 1 to 12 carbon atoms.

Particularly preferred unsaturated carboxylic acids are acrylic acid, methacrylic acid, ethacrylic acid, α-chloroacrylic acid, α-cyanoacrylic acid, crotonic acid, α-phenylacrylic acid, maleic acid, maleic acid anhydride, fumaric acid, itaconic acid, citraconic acid, methylenemalonic acid, sorbic acid, cinnamic acid, or the mixtures thereof. Of course, the unsaturated dicarboxylic acids may also be used.

In the sulfonic acid group-containing monomers, those of formula

R⁵(R⁶)C═C(R⁷)—X—SO₃H

are preferred, in which R⁵ to R⁷ independently stand for —H, —CH₃, a straight-chain or branched saturated alkyl moiety containing 2 to 12 carbon atoms, a straight-chain or branched, singly or multiply unsaturated alkenyl moiety containing 2 to 12 carbon atoms, alkyl or alkenyl moieties substituted with —NH₂, —OH, or —COOH, or for —COOH or —COOR⁴, where R⁴ is a saturated or unsaturated, straight-chain or branched hydrocarbon moiety containing 1 to 12 carbon atoms, and X stands for an optionally present spacer group selected from —(CH₂)ₙ— where n=0 to 4, —COO—(CH₂)ₖ— where k=1 to 6, —C(O)—NH—C(CH₃)₂—, —C(O)—NH—C(CH₃)₂—CH₂—, and —C(O)—NH—CH(CH₃)—CH₂—.

Among these monomers, those of formulas

H₂C═CH—X—SO₃H

H₂C═C(CH₃)—X—SO₃H

HO₃S—X—(R⁶)C═C(R⁷)—X—SO₃H

are preferred, in which R⁶ and R⁷ are independently selected from —H, —CH₃, —CH₂CH₃, —CH₂CH₂CH₃, and —CH(CH₃)₂, and X stands for an optionally present spacer group selected from —(CH₂)ₙ— where n=0 to 4, —COO—(CH₂)ₖ— where k=1 to 6, —C(O)—NH—C(CH₃)₂—, —C(O)—NH—C(CH₃)₂—CH₂—, and —C(O)—NH—CH(CH₃)—CH₂—.

Particularly preferred sulfonic acid group-containing monomers are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethacrylamide, sulfomethylmethacrylamide, and mixtures of the mentioned acids or the water-soluble salts thereof.

The sulfonic acid groups may be completely or partially present in neutralized form in the polymers; i.e., the acidic hydrogen atom of the sulfonic acid group may be replaced with metal ions, preferably alkali metal ions, and in particular sodium ions, in some or all sulfonic acid groups. The use of copolymers containing sulfonic acid groups that are partially or completely neutralized is preferred as contemplated herein

For copolymers which contain only carboxylic acid group-containing monomers and sulfonic acid group-containing monomers, the monomer distribution of the copolymers preferably used as contemplated herein is in each case about 5 to about 95% by weight, the proportion of the sulfonic acid group-containing monomer is particularly preferably about 50 to about 90% by weight, and the proportion of the carboxylic acid group-containing monomer is particularly preferably about 10 to about 50% by weight, the monomers preferably being selected from those mentioned above.

The molar mass of the sulfo copolymers preferably used as contemplated herein may be varied in order to adapt the properties of the polymers to the desired purpose. Preferred cleaning agents are characterized in that the copolymers have molar masses of about 2000 to about 200,000 gmol⁻¹, preferably about 4000 to about 25,000 gmol⁻¹, and in particular about 5000 to about 15,000 gmol⁻¹.

In another preferred embodiment, the copolymers include, in addition to carboxyl group-containing monomer and sulfonic acid group-containing monomer, at least one nonionic, preferably hydrophobic, monomer. It has been possible to improve in particular the rinsing performance of machine dishwasher detergents as contemplated herein by use of these hydrophobically modified polymers.

Anionic copolymers comprising carboxylic acid group-containing monomers, sulfonic acid group-containing monomers, and nonionic monomers, in particular hydrophobic monomers, are therefore preferred as contemplated herein.

Preferably used as nonionic monomers are monomers of the general formula R¹(R²)C═C(R³)—X—R⁴, in which R¹ to R³ independently stand for —H, —CH₃, or —C₂H₅, X stands for an optionally present spacer group selected from —CH₂—, —C(O)O—, and —C(O)—NH—, and R⁴ stands for a straight-chain or branched saturated alkyl moiety containing 2 to 22 carbon atoms or for an unsaturated, preferably aromatic, moiety containing 6 to 22 carbon atoms.

Particularly preferred nonionic monomers are butene, isobutene, pentene, 3-methylbutene, 2-methylbutene, cyclopentene, hexene, 1-hexene, 2-methyl-1-pentene, 3-methyl-1-pentene, cyclohexene, methylcyclopentene, cycloheptene, methylcyclohexene, 2,4,4-trimethyl-1-pentene, 2,4,4-trimethyl-2-pentene, 2,3-dimethyl-1-hexene, 2,4-dimethyl-1-hexene, 2,5-dimethyl-1-hexene, 3,5-dimethyl-1-hexene, 4,4-dimethyl-1-hexane, ethylcyclohexyne, 1-octene, α-olefins containing 10 or more carbon atoms, for example 1-decene, 1-dodecene, 1-hexadecene, 1-octadecene, and C22 α-olefin, 2-styrene, α-methylstyrene, 3-methylstyrene, 4-propylstyrene, 4-cyclohexylstyrene, 4-dodecylstyrene, 2-ethyl-4-benzylstyrene, 1-vinylnaphthalene, 2-vinylnaphthalene, acrylic acid methyl ester, acrylic acid ethyl ester, acrylic acid propyl ester, acrylic acid butyl ester, acrylic acid pentyl ester, acrylic acid hexyl ester, methacrylic acid methyl ester, N-(methyl)acrylamide, acrylic acid-2-ethyl hexyl ester, methacrylic acid-2-ethyl hexyl ester, N-(2-ethylhexyl)acrylamide, acrylic acid octyl ester, methacrylic acid octyl ester, N-(octyl)acrylamide, acrylic acid lauryl ester, methacrylic acid lauryl ester, N-(lauryl)acrylamide, acrylic acid stearyl ester, methacrylic acid stearyl ester, N-(stearyl)acrylamide, acrylic acid behenyl ester, methacrylic acid behenyl ester, and N-(behenyl)acrylamide, or the mixtures thereof.

The monomer distribution of the hydrophobically modified copolymers preferably used as contemplated herein is preferably in each case about 5 to about 80% by weight of the sulfonic acid group-containing monomer, the hydrophobic monomer, and the carboxylic acid group-containing monomer; the proportion of the sulfonic acid group-containing monomer and of the hydrophobic monomer is particularly preferably about 5 to about 30% by weight in each case, and the proportion of the carboxylic acid group-containing monomer is about 60 to about 80% by weight, the monomers preferably being selected from those mentioned above.

The cleaning agents may contain alkali metal hydroxides in addition to the builders mentioned above. These alkali carriers are preferably used in the cleaning agents in only small quantities, preferably in quantities below 10% by weight, preferably below 6% by weight, particularly preferably below 5% by weight, in each case based on the total weight of the cleaning agent. Preferred cleaning agents as contemplated herein are free of alkali metal hydroxides.

The cleaning agents as contemplated herein preferably also contain at least one nonionic surfactant. All nonionic surfactants known to those skilled in the art may be used as nonionic surfactants. Low-foaming nonionic surfactants are preferably used, in particular alkoxylated, in particular ethoxylated, low-foaming nonionic surfactants. The machine dishwasher detergents particularly preferably contain nonionic surfactants from the group of alkoxylated alcohols.

Nonionic surfactants having a melting point above room temperature are particularly preferred. Nonionic surfactant(s) having a melting point above 20° C., preferably above 25° C., particularly preferably between about 25 and about 60° C., and in particular between about 26.6 and about 43.3° C., is/are particularly preferred.

Surfactants preferably to be used come from the groups of alkoxylated nonionic surfactants, in particular the ethoxylated primary alcohols and mixtures of these surfactants with structurally complex surfactants such as polyoxypropylene/polyoxyethylene/polyoxypropylene ((PO/EO/PO) surfactants). Such (PO/EO/PO) nonionic surfactants are also characterized by good foaming control.

Within the scope of the present disclosure, low-foaming nonionic surfactants having alternating ethylene oxide and alkylene oxide units have proven to be particularly preferred nonionic surfactants. Among these, surfactants having EO-AO-EO-AO blocks are preferred, in each case one to ten EO or AO groups being bonded to one another before being followed by a block composed of the respective other group. Nonionic surfactants of the general formula

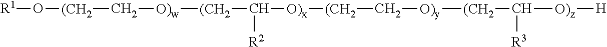

are preferred here, in which R¹ stands for a straight-chain or branched, saturated, or singly or multiply unsaturated C₆₋₂₄ alkyl or alkenyl moiety; each group R² or R³ is independently selected from —CH₃, —CH₂CH₃, —CH₂CH₂—CH₃, CH(CH₃)₂, and the indices w, x, y, z independently stand for integers from 1 to 6.

Thus, preferred in particular are nonionic surfactants having a C₉₋₁₅ alkyl moiety containing 1 to 4 ethylene oxide units, followed by 1 to 4 propylene oxide units, followed by 1 to 4 ethylene oxide units, followed by 1 to 4 propylene oxide units.

Preferred nonionic surfactants are those of general formula R¹—CH(OH)CH₂O-(AO)_{w}-(A′O)ₓ-(A″O)_{y}-(A′″O)_{z}—R₂, in which
R¹ stands for a straight-chain or branched, saturated, or singly or multiply unsaturated C₆₋₂₄ alkyl or alkenyl moiety;
R² stands for H or a linear or branched hydrocarbon moiety containing 2 to 26 carbon atoms;
A, A′, A″, and A′″ independently stand for a moiety from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃),
w, x, y, and z stand for values between 0.5 and 120, where x, y, and/or z may also be 0.

By addition of the above-mentioned nonionic surfactants of general formula R¹—CH(OH)CH₂O-(AO)_{w}-(A′O)ₓ-(A″O)_{y}-(A′″O)_{z}—R₂, also referred to below as “hydroxy mixed ethers,” the cleaning power of the preparations as contemplated herein may be greatly improved, in particular in comparison to surfactant-free systems as well as to systems containing alternative nonionic surfactants, for example from the group of polyalkoxylated fatty alcohols.

Poly(oxyalkylated) nonionic surfactants closed by a terminal group in particular are preferred which according to the formula R¹O[CH₂CH₂O]_{X}CH₂CH(OH)R² have, in addition to a moiety R¹ which stands for linear or branched, saturated or unsaturated, aliphatic or aromatic hydrocarbon moieties containing 2 to 30 carbon atoms, preferably 4 to 22 carbon atoms, also have a linear or branched, saturated or unsaturated, aliphatic or aromatic hydrocarbon moiety R² containing 1 to 30 carbon atoms, where x stands for values between 1 and 90, preferably for values between 30 and 80, and in particular for values between 30 and 60.

Particularly preferred are surfactants of the formula R¹O[CH₂CH(CH₃)O]ₓ[CH₂CH₂O]_{y}CH₂CH(OH)R₂, in which R¹ stands for a linear or branched aliphatic hydrocarbon moiety containing 4 to 18 carbon atoms or mixtures thereof, R² stands for a linear or branched hydrocarbon moiety containing 2 to 26 carbon atoms or mixtures thereof, and x stands for values between 0.5 and 1.5 and y stands for a value of at least 15.

The group of these nonionic surfactants includes, for example, C₂₋₂₆ fatty alcohol-(PO)₁-(EO)₁₅₋₄₀-2-hydroxyalkyl ethers, in particular also C₈₋₁₀ fatty alcohol-(PO)₁-(EO)₂₂-2-hydroxydecyl ethers.

Also particularly preferred are poly(oxyalkylated) nonionic surfactants, closed by a terminal group, of the formula R¹O[CH₂CH₂O]ₓ[CH₂CH(R³)O]_{y}CH₂CH(OH)R², in which R¹ and R² independently stand for a linear or branched, saturated, or singly or multiply unsaturated hydrocarbon moiety containing 2 to 26 carbon atoms, R³ is independently selected from —CH₃, —CH₂CH₃, —CH₂CH₂—CH₃, —CH(CH₃)₂, but preferably for —CH₃, and x and y independently stand for values between 1 and 32, wherein nonionic surfactants with R³=—CH₃, and where x has values of 15 to 32 and y has values of 0.5 and 1.5, are very particularly preferred.

Further nonionic surfactants which may preferably be used are poly(oxyalkylated) nonionic surfactants, closed by a terminal group, of the formula R¹O[CH₂CH(R³)O]ₓ[CH₂]ₖCH(OH)[CH₂]ⱼOR², in which R¹ and R² stand for linear or branched, saturated or unsaturated, aliphatic or aromatic hydrocarbon moieties containing 1 to 30 carbon atoms, R³ stands for H or a methyl, ethyl, n-propyl, isopropyl, n-butyl, 2-butyl, or 2-methyl-2-butyl moiety, x stands for values between 1 and 30, and k and j stand for values between 1 and 12, preferably between 1 and 5. If the value x 2, each R³ in the above formula R¹O[CH₂CH(R³)O]ₓ[CH₂]ₖCH(OH)[CH₂]ⱼOR² may be different. R¹ and R² are preferably linear or branched, saturated or unsaturated, aliphatic or aromatic hydrocarbon moieties containing 6 to 22 carbon atoms, with moieties containing 8 to 18 C atoms being particularly preferred. H, —CH₃, or —CH₂CH₃ is particularly preferred for the moiety R³. Particularly preferred values for x are in the range of 1 to 20, in particular 6 to 15.

As described above, each R³ in the above formula may be different if x 2. The alkylene oxide unit in brackets may thus be varied. If x stands for 3, for example, the moiety R³ may be selected in order to form ethylene oxide units (R³═H) or propylene oxide units (R³═CH₃), which may be joined to one another in any sequence, for example (EO)(PO)(EO), (EO)(EO)(PO), (EO)(EO)(EO), (PO)(EO)(PO), (PO)(PO)(EO), and (PO)(PO)(PO). The value of 3 for x has been selected by way of example, and may in fact be larger; the range of variation increases with increasing x values, and for example includes a large number of (EO) groups combined with a small number of (PO) groups, or vice versa.

Particularly preferred poly(oxyalkylated) alcohols, closed by a terminal group, of the above formula have values of k=1 and j=1, thus simplifying the above formula to R¹O[CH₂CH(R³)O]ₓCH₂CH(OH)CH₂OR². In the latter-mentioned formula, R¹, R², and R³ are defined as above, and x stands for numbers from 1 to 30, preferably 1 to 20, and in particular 6 to 18. Surfactants are particularly preferred in which the moieties R¹ and R² contain 9 to 14 C atoms, R³ stands for H, and x has values of 6 to 15.

Lastly, the nonionic surfactants of the general formula R¹—CH(OH)CH₂O-(AO)_{w}—R² have proven to be particularly effective, in which
R¹ stands for a straight-chain or branched, saturated, or singly or multiply unsaturated C₆₋₂₄ alkyl or alkenyl moiety;
R² stands for a linear or branched hydrocarbon moiety containing 2 to 26 carbon atoms;
A stands for a moiety from the group CH₂CH₂, CH₂CH₂CH₂, CH₂CH(CH₃), preferably for CH₂CH₂, and
w stands for values between 1 and 120, preferably 10 to 80, in particular 20 to 40.

The group of these nonionic surfactants includes, for example, the C₄₋₂₂ fatty alcohol-(EO)₁₀₋₈₀-2-hydroxyalkyl ethers, in particular also the C₈₋₁₂ fatty alcohol-(EO)₂₂-2-hydroxydecyl ethers, and the C₄₋₂₂ fatty alcohol-(EO)₄₀₋₈₀-2-hydroxyalkyl ethers.

In various embodiments of the disclosure, instead of the above-defined hydroxy mixed ethers closed by a terminal group, the corresponding hydroxy mixed ethers not closed by a terminal group may be used. These compounds may satisfy the above formulas, except that R² is hydrogen, and R¹, R³, A, A′, A,″ A′″, w, x, y, and z are defined as above.

Preferred liquid cleaning agents are characterized in that the cleaning agent contains at least one nonionic surfactant, preferably a nonionic surfactant from the group of hydroxy mixed ethers, wherein the weight percentage of the nonionic surfactant in the total weight of the cleaning agent is preferably about 0.1 to about 10% by weight, more preferably about 0.5 to about 8.0% by weight, and in particular about 1.0 to about 4.0% by weight.

In general, the pH of the cleaning agent may be adjusted by means of customary pH regulators, the pH being selected depending on the desired purpose. In various embodiments, the pH is in a range of about 5.5 to about 10.5, preferably about 5.5 to about 9.5, more preferably about 7 to about 9, in particular greater than 7, most preferably in the range about 7.5 to about 8.5. Acids and/or alkalis, preferably alkalis, are used as pH adjusters. Suitable acids are in particular organic acids such as acetic acid, citric acid, glycolic acid, lactic acid, succinic acid, adipic acid, malic acid, tartaric acid, and gluconic acid, or also amidosulfonic acid. However, the mineral acids hydrochloric acid, sulfuric acid, and nitric acid or the mixtures thereof may also be used. Suitable bases come from the group of alkali metal and alkaline earth metal hydroxides and carbonates, in particular the alkali metal hydroxides, of which potassium hydroxide and in particular sodium hydroxide are preferred. Particularly preferred, however, is volatile alkali, for example in the form of ammonia and/or alkanolamines, which may contain up to 9 C atoms in the molecule. The alkanolamine is preferably selected from the group comprising mono-, di-, triethanolamine and mono-, di-, tripropanolamine, and the mixtures thereof. The alkanolamine is preferably contained in agents as contemplated herein in a quantity of about 0.5 to about 10% by weight, in particular in a quantity of about 1 to about 6% by weight.

For adjusting and/or stabilizing the pH, the agent as contemplated herein may contain one or more buffer substances (INCI: Buffering Agents), typically in quantities of about 0.001 to about 5% by weight. Buffer substances which at the same time are complexing agents or even chelating agents (chelators, INCI: Chelating Agents) are preferred. Particularly preferred buffer substances are citric acid and citrates, in particular sodium citrate and potassium citrate, for example trisodium citrate.2 H₂O and tripotassium citrate.H₂O.

The agents as contemplated herein preferably contain at least one further component, preferably selected from the group comprising anionic, cationic, and amphoteric surfactants, bleaching agents, bleach activators, bleach catalysts, polymers, non-amylase and non-protease enzymes, thickeners, sequestering agents, electrolytes, corrosion inhibitors, in particular silver protectants, glass corrosion inhibitors, foam inhibitors, dyes, fragrances, bittering agents, and antimicrobial active substances.

Preferred anionic surfactants are fatty alcohol sulfates, fatty alcohol ether sulfates, dialkyl ether sulfates, monoglyceride sulfates, alkylbenzene sulfonates, olefin sulfonates, alkane sulfonates, ether sulfonates, n-alkyl ether sulfonates, ester sulfonates, and lignin sulfonates. Likewise usable within the scope of the present disclosure are fatty acid cyanamides, sulfosuccinates (sulfosuccinic acid esters), in particular sulfosuccinic acid mono- and di-C₈-C₁₈ alkyl esters, sulfosuccinamates, sulfosuccinamides, fatty acid isethionates, acylaminoalkane sulfonates (fatty acid taurides), fatty acid sarcosinates, ether carboxylic acids, and alkyl (ether) phosphates as well as α-sulfo fatty acid salts, acylglutamates, monoglyceride disulfates, and alkyl ethers of glycerin disulfate.

The anionic surfactants are preferably used as sodium salts, but may also be contained as other alkali metal or alkaline earth metal salts, for example potassium or magnesium salts, and in the form of ammonium or mono-, di-, tri-, or tetraalkylammonium salts, and in the case of sulfonates, also in the form of their corresponding acid, for example dodecylbenzenesulfonic acid.

Examples of suitable amphoteric surfactants are betaines of formula (Rⁱⁱⁱ)(R^{iv})(R^{v})N⁺CH₂COO⁻, in which Rⁱⁱⁱ means an alkyl moiety containing 8 to 25, preferably 10 to 21, carbon atoms, optionally interrupted by heteroatoms or heteroatom groups, and R^{iv} and R^{v} mean identical or different alkyl moieties containing 1 to 3 carbon atoms, in particular C₁₀-C₁₈ alkyl dimethyl carboxymethyl betaine and C₁₁-C₁₇ alkyl amidopropyl dimethyl carboxymethyl betaine.

Suitable cationic surfactants include, among others, quaternary ammonium compounds of the formula (R^{vi})(R^{vii})(R^{viii})(R^{ix})N⁺X⁻, in which R^{vi} to R^{ix} stand for four alkyl moieties of the same type or different types, in particular two long-chain and two short-chain alkyl moieties, and X⁻ stands for an anion, in particular a halide ion, for example didecyldimethylammonium chloride, alkylbenzyldidecylammonium chloride, and the mixtures thereof. Further suitable cationic surfactants are the quaternary surface-active compounds, in particular having a sulfonium, phosphonium, iodonium, or arsonium group, which are also known as antimicrobial active substances. By use of quaternary surface-active compounds having antimicrobial activity, the agent may be provided with antimicrobial activity, or its existing antimicrobial activity optionally due to other ingredients may be improved.

The enzymes include, in addition to the proteases and amylases mentioned above, in particular lipases, hemicellulases, cellulases, perhydrolases, and oxidoreductases, and preferably the mixtures thereof. In principle, these enzymes are of natural origin; starting from the natural molecules, improved variants are available for use in cleaning agents, which accordingly are preferably used. Cleaning agents as contemplated herein preferably contain these enzymes in total quantities of about 1×10⁻⁶ to about 5% by weight, based on active protein.

Lipases or cutinases are usable as contemplated herein, in particular due to their triglyceride-cleaving activities, but also in order to produce peracids in situ from suitable precursors. These include, for example, the lipases originally obtainable from Humicola lanuginosa (Thermomyces lanuginosus) or refined, in particular those with the D96L amino acid exchange.

Furthermore, enzymes which are encompassed under the term “hemicellulases” may be used. These include, for example, mannanases, xanthan lyases, pectin lyases (pectinases), pectinesterases, pectate lyases, xyloglucanases (xylanases), pullulanases, and β-glucanases.

To increase the bleaching effect, oxidoreductases, for example oxidases, oxygenases, catalases, peroxidases such as halo-, chloro-, bromo-, lignin, glucose, or manganese peroxidases, dioxygenases, or laccases (phenoloxidases, polyphenoloxidases) may be used as contemplated herein. In addition, preferably organic, particularly preferably aromatic, compounds which interact with the enzymes are advantageously added to intensify the activity of the oxidoreductases in question (enhancers), or, for greatly different redox potentials between the oxidizing enzymes and the soils, to ensure the electron flow (mediators).

The enzymes may be provided and formulated as described above for the proteases and amylases.

Zinc salts, in particular zinc acetate, are preferably used as glass corrosion inhibitors. Glass corrosion inhibitors are preferably contained in agents as contemplated herein in a quantity of about 0.05 to about 5% by weight, in particular in a quantity of about 0.1 to about 2% by weight.

In various embodiments, the cleaning agent has a viscosity, directly following manufacture, above 2000 mPas (Brookfield viscometer DV-II+Pro, spindle 25, 30 rpm, 20° C.), in particular between about 2000 and about 10,000 mPas. After storage the viscosity may be higher, for example greater than 10,000 mPas, for example in the range of about 10,000 to about 50,000 mPas, preferably around 35,000 mPas (Brookfield viscometer DV-II+Pro, spindle 25, 5 rpm, 20° C.).

The cleaning agent may be present in a water-insoluble, water-soluble, or water-dispersible package. The disclosure therefore further relates to kits containing the cleaning agent together with such a package. The cleaning agent may be provided in such a way that single portions are packaged separately.

The cleaning agent as contemplated herein is preferably contained in a water-soluble package. The water-soluble package allows portioning of the cleaning agent. The quantity of cleaning agent in the single-use package is preferably about 5 to about 50 g, particularly preferably about 10 to about 30 g, most preferably about 15 to about 25 g.

The water-soluble wrapping/package is preferably a deep-drawn body or an injection-molded body.

The water-soluble containers/wrappings/packages may also be produced by injection molding. Injection molding refers to the shaping of a molding compound in such a way that the compound contained in an injection cylinder for more than one injection molding operation is plastically softened under the action of heat, and flows under pressure through a nozzle into the cavity of a mold which is closed beforehand. The method is used primarily for noncurable molding compounds, which solidify in the mold by cooling. Injection molding is a very cost-effective, modern process for manufacturing articles that are formed without machining, and is particularly suitable for automated mass production. In practical operation, the thermoplastic molding compounds (powders, grains, cubes, pastes, among others) are heated to liquefaction (up to 180° C.), whereupon they are injected under high pressure (up to 140 MPa) into closed, preferably water-cooled, hollow molds in two parts, i.e., made up of a cavity (formerly: female die) and a core (formerly: male die), where they cool and solidify. Piston injection molding machines and screw injection molding machines may be used.

Such molded bodies may also have one, two, three, or more chambers and may be filled with liquid and/or solid compositions, one of which is one of the compositions as contemplated herein. It is possible, for example, to close the chambers on the open side, either with a second injection-molded body or with one or more water-soluble films (in particular as described herein). The release of the compositions present in the chambers may thus be controlled freely according to the desired time of release. The overall agent may be released either all at once (either directly at the start of the cleaning cycle or at a certain time during the cleaning cycle), or at certain, separate times during the dishwasher cycle by varying the film composition (for example, as a function of the temperature of the wash water).

The water-soluble wrapping is preferably made of a water-soluble film material selected from the group comprising polymers or polymer mixtures. The wrapping may be formed from one or two or more layers of the water-soluble film material. The water-soluble film material of the first layer and of the additional layers, if present, may be the same or different. Films which may be glued and/or sealed to form packages such as tubes or cushions, for example, after they have been filled with an agent are particularly preferred.

It is preferred that the water-soluble wrapping contains polyvinyl alcohol or a polyvinyl alcohol copolymer. Water-soluble wrappings containing polyvinyl alcohol or a polyvinyl alcohol copolymer have good stability with sufficiently high solubility in water, in particular solubility in cold water.

Suitable water-soluble films for manufacturing the water-soluble wrapping are preferably based on a polyvinyl alcohol or a polyvinyl alcohol copolymer having a molecular weight in the range of about 10,000 to about 1,000,000 gmol⁻¹, preferably about 20,000 to about 500,000 gmol⁻¹, particularly preferably about 30,000 to about 100,000 gmol⁻¹, and in particular about 40,000 to about 80,000 gmol⁻¹.

Polyvinyl alcohol is usually produced by hydrolysis of polyvinyl acetate, since a direct synthesis pathway is not possible. The same applies for polyvinyl alcohol copolymers, which are corresponding produced from polyvinyl acetate copolymers. It is preferred for at least one layer of the water-soluble wrapping to include polyvinyl alcohol having a degree of hydrolysis of 70 to 100 mol-%, preferably 80 to 90 mol-%, particularly preferably 81 to 89 mol-%, and in particular 82 to 88 mol-%.

In addition, a polymer selected from the group comprising (meth)acrylic acid-containing (co)polymers, polyacrylamides, oxazoline polymers, polystyrene sulfonates, polyurethanes, polyesters, polyethers, polylactic acid, or mixtures of the above polymers may be added to a polyvinyl alcohol-containing film material which is suitable for manufacture of the water-soluble wrapping. Polylactic acids represent a preferred additional polymer.

Preferred polyvinyl alcohol copolymers include, in addition to vinyl alcohol, dicarboxylic acids as further monomers. Suitable dicarboxylic acids are itaconic acid, malonic acid, succinic acid, and mixtures thereof, with itaconic acid being preferred.

Likewise preferred polyvinyl alcohol copolymers include, in addition to vinyl alcohol, an ethylenically unsaturated carboxylic acid, the salts thereof, or the esters thereof. Such polyvinyl alcohol copolymers, in addition to vinyl alcohol, particularly preferably contain acrylic acid, methacrylic acid, acrylic acid ester, methacrylic acid ester, or mixtures thereof.

It may be preferred that the film material contains further additives. The film material may contain, for example, plasticizers such as dipropylene glycol, ethylene glycol, diethylene glycol, propylene glycol, glycerin, sorbitol, mannitol, or mixtures thereof. Further additives include, for example, release aids, fillers, crosslinking agents, surfactants, antioxidants, UV absorbers, antiblocking agents, non-stick agents, or mixtures thereof.

Suitable water-soluble films for use in the water-soluble wrappings of the water-soluble packages as contemplated herein are films marketed by MonoSol LLC, for example under the names M8630, C8400, or M8900. Other suitable films include those with the names Solublon® PT, Solublon® GA, Solublon® KC, or Solublon® KL from Aicello Chemical Europe GmbH, or the VF-HP films from Kuraray.

The cleaning agents as contemplated herein may be used as dishwashing detergents, in particular machine dishwasher detergents. The corresponding use is likewise the subject matter of the disclosure. The disclosure further relates to a dishwashing method, in particular a machine dishwashing method, in which a cleaning agent as contemplated herein is used.

Therefore, the subject matter of the present patent application further relates to a method for cleaning dishes in a dishwasher, in which the agent is metered into the interior of a dishwasher during a dishwashing program, before the main wash cycle begins or during the course of the main wash cycle. The metering or the introduction of the agent into the interior of the dishwasher may take place manually, but the agent is preferably metered into the interior of the dishwasher via the dosing chamber. In various embodiments of the disclosure, in such dishwashing methods the (washing) temperature is preferably 50° C. or lower, particularly preferably 45° C. or lower, more preferably 40° C. or lower.

All enzyme combinations described as special embodiments in conjunction with the cleaning agents disclosed herein are likewise usable in the described method and uses.

### EXAMPLES

### Example 1: Liquid Dishwasher Detergent Formulations Containing Proteases

TABLE 1
Composition of the machine dishwasher detergent
(expressed in % by weight of active substance)

| | Formulation 1 | Formulation 2 |
|---|---|---|
| Glycerin | 26 | 26 |
| 1,2-Propylene glycol | 10.00 | 10.00 |
| Sulfopolymer | 8.5 | 8.5 |
| Potassium tripolyphosphate | 21 | 21 |
| Na citrate dihydrate | 4.00 | 4.00 |
| HEDP | 2.40 | 2.40 |
| Nonionic surfactant | 2.00 | 2.00 |
| Ethanolamine | 3.50 | 3.50 |
| Polyacrylate | 0.20 | 0.20 |
| Protease 2 | 0.00 | 0.20 |
| Amylase 2 | 0.015 | 0.015 |
| Protease 1 | 0.3 | 0.1 |
| Amylase 1 | 0.00 | 0.00 |
| Zinc acetate | 0.20 | 0.20 |
| Bittering agent, preservative, dye, | To make 100 | To make 100 |
| fragrance, water | | |

Data refer to the weight percentage of the particular active protein:
Protease 1 = solid, SEQ ID NO: 8
Protease 2 = liquid, SEQID NO: 9
Amylase 1 = solid, variant of α-amylase of Bacillus sp. No. 707
Amylase 2 = liquid, Stainzyme ® 12L (Novozymes, DK)

Cleaning power on protease-sensitive egg yolk soils

Dishes soiled with egg yolk were washed in a Miele GSL dishwasher at 50° C. (“normal” program) and 21° dH water hardness, using a liquid dishwasher detergent composition (for composition, see Table 1: formulation 1=comparative formulation, formulation 2=formulation as contemplated herein). The cleaning power was gravimetrically determined after each wash cycle (rating from 1 to 10; the higher the value, the better the performance; differences of at least 1 are significant). The results for the tested formulations are listed in Table 2 as arithmetic averages. Higher values mean better cleaning power.

TABLE 2
Cleaning power on egg yolk

| | Egg yolk |
|---|---|
| Formulation 1 | 2.6 |
| Formulation 2 | 3.5 |

It is clearly apparent from Table 2 that the combination of the two different enzyme formulations results in a marked improvement in the cleaning power, even though the two formulations have the same active enzyme content.

### Example 2: Liquid Dishwasher Detergent Formulations Containing Amylases

TABLE 3
Composition of the machine dishwasher detergent
(expressed in % by weight active substance)

| | Formu- | Formu- | Formu- |
|---|---|---|---|
| | lation 3 | lation 4 | lation 5 |
| Glycerin | 26 | 26 | 26 |
| 1,2-Propylene glycol | 10.00 | 10.00 | 10.00 |
| Sulfopolymer | 8.5 | 8.5 | 8.5 |
| Potassium tripolyphosphate | 21 | 21 | 21 |
| Na citrate dihydrate | 4.00 | 4.00 | 4.00 |
| HEDP | 2.40 | 2.40 | 2.40 |
| Nonionic surfactant | 2.00 | 2.00 | 2.00 |
| Ethanolamine | 3.50 | 3.50 | 3.50 |
| Polyacrylate | 0.20 | 0.20 | 0.20 |
| Protease 2 | 0.20 | 0.20 | 0.20 |
| Amylase 2 | 0.075 | 0.00 | 0.015 |
| Protease 1 | 0.00 | 0.00 | 0.00 |
| Amylase 1 | 0.025 | 0.05 | 0.00 |
| Zinc acetate | 0.20 | 0.20 | 0.20 |
| Bittering agent, preservative, | To make 100 | To make 100 | To make 100 |
| dye, fragrance, water | | | |

Protease 1 = solid, SEQ ID NO: 8
Protease 2 = liquid, SEQID NO: 9
Amylase 1 = solid, variant of α-amylase of Bacillus sp. No. 707
Amylase 2 = liquid, Stainzyme ® 12L (Novozymes, DK)

Dishes soiled with oatmeal or spaghetti were washed in a Miele GSL dishwasher at 50° C. (“normal” program) and 21° dH water hardness, using a liquid dishwasher detergent composition (for composition, see Table 3: formulations 4/5=comparative formulation, formulation 3=formulation as contemplated herein). The cleaning power was visually determined according to IKW criteria after each wash cycle (rating from 1 to 10; the higher the value, the better the performance; differences of at least 1 are significant). The results for the tested formulations are listed in Table 4 as arithmetic averages. Higher values mean better cleaning power.

TABLE 4
Cleaning power on oatmeal/spaghetti

| | Oatmeal | Spaghetti |
|---|---|---|
| Formulation 3 | 7.8 | 3.9 |
| Formulation 4 | 7.0 | 2.6 |
| Formulation 5 | 7.3 | 3.6 |

It is clearly apparent from Table 4 that the combination as contemplated herein results in increased cleaning power.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing an exemplary embodiment of the disclosure. It being understood that various changes may be made in the function and arrangement of elements described in an exemplary embodiment without departing from the scope of the disclosure as set forth in the appended claims.

1. A liquid cleaning agent, comprising:
at least one liquid enzyme formulation which comprises at least one protease and/or at least one amylase; and
at least one solid enzyme formulation which comprises at least one protease and/or at least one amylase, wherein the solid enzyme formulation is homogeneously suspended in the liquid cleaning agent.

2. The cleaning agent according to claim 1, wherein the cleaning agent comprises at least one first amylase and/or at least one second amylase, wherein:
the first amylase is contained in the solid enzyme formulation; and
the second amylase is contained in the liquid enzyme formulation.

3. The cleaning agent according to claim 1, wherein:
the first amylase is an α-amylase of Bacillus sp. No. 707 or a functional fragment or a variant thereof; and/or
the first amylase includes an amino acid sequence which is at least 80% identical over its entire length to the amino acid sequence stated in SEQ ID NO:1.

4. The cleaning agent according to claim 1, wherein:
the second amylase is an AA560 α-amylase of Bacillus sp. or a functional fragment or a variant thereof; and/or
the second amylase includes an amino acid sequence which is at least 80% identical over its entire length to the amino acid sequence stated in SEQ ID NO:2.

5. The cleaning agent according to claim 1, wherein the cleaning agent comprises at least one first protease and/or at least one second protease, wherein:
the first protease is comprised in the solid enzyme formulation; and
the second protease is comprised in the liquid enzyme formulation.

6. The cleaning agent according to claim 5, wherein the first protease comprises a protease of Bacillus alcalophilus PB92 or a functional fragment or a variant thereof, in particular a protease having an amino acid sequence which is at least 80%, identical over its entire length to the amino acid sequence stated in SEQ ID NO:4, and which has at least one amino acid substitution at one of the following positions: 32, 33, 48-54, 58-62, 94-107, 116, 123-133, 150, 152-156, 158-161, 164, 169, 175-186, 197, 198, 203-216 in the count according to SEQ ID NO:4.

7. The cleaning agent according to claim 5, wherein the second protease:
comprises a subtilisin 309 of Bacillus lentus or a functional fragment or a variant thereof, the subtilisin has an amino acid sequence which is at least 80% identical over its entire length to the amino acid sequence stated in SEQ ID NO:3, and has at least one amino acid substitution at one of the positions 9, 15, 66, 212, and 239 in the count according to SEQ ID NO:3;
comprises a subtilisin 309 of Bacillus lentus or a functional fragment or a variant thereof, the subtilisin has an amino acid sequence which is at least 80% identical over its entire length to the amino acid sequence stated in SEQ ID NO:3, and has an amino acid substitution at position 99 and an insertion of an amino acid between the amino acids at positions 99 and 100 in the count according to SEQ ID NO:3;
comprises an alkaline protease of Bacillus lentus DSM 5483 or a functional fragment or a variant thereof, the protease has an amino acid sequence which is at least 80% identical over its entire length to the amino acid sequence stated in SEQ ID NO:5, and has at least one amino acid substitution at one, two, three, or four of the following positions: 3, 4, 99, and 199 in the count according to SEQ ID NO:5; or
(d) has an amino acid sequence according to one of SEQ ID NOs:6-10.

8. The cleaning agent according to claim 1, wherein:
the solid enzyme formulation is comprised in a quantity of 0.01 to 5% by weight based on the total weight of the cleaning agent, wherein the solid enzyme formulation has an active enzyme content of 2 to 20% by weight; and/or
the liquid enzyme formulation is comprised in a quantity of 0.01 to 8% by weight based on the total weight of the cleaning agent, wherein the liquid enzyme formulation in particular has an active enzyme content of 1 to 6% by weight.

9. The cleaning agent according to claim 1, wherein the cleaning agent comprises the liquid enzyme formulation and the solid enzyme formulation in a mass ratio of 10:1 to 1:10.

10. The cleaning agent according to claim 1, wherein the cleaning agent:
comprises at least one phosphate-containing builder component;
comprises at least one polyhydric alcohol; and
has a water content less than 50% by weight.

11. The cleaning agent according to claim 1, wherein the cleaning agent comprises at least one sulfopolymer.

12. (canceled)

13. The cleaning agent according to claim 1, wherein the cleaning agent is a machine dishwasher detergent and:
is present in preportioned form; and/or
contains multiple compositions that are spatially separate from one another; and/or
is present in a water-insoluble, water-soluble, or water-dispersible package.

14. (canceled)

15. A method for cleaning dishes in an automatic dishwasher, the method comprising the steps of:
providing a cleaning agent according to claim 1; and
dosing the liquid cleaning agent into the interior of the dishwasher.

16. The cleaning agent according to claim 3, wherein the first amylase has at least one amino acid substitution at one of the positions 172, 202, 208, 255, and 261 in the count according to SEQ ID NO:1.

17. The cleaning agent according to claim 16, wherein the first amylase has at least one amino acid substitution selected from the group comprising M202L, M202V, M2025, M202T, M202I, M202Q, M202W, S255N, and R172Q.

18. The cleaning agent according to claim 4, wherein the second amylase has at least one amino acid substitution at one of the positions 9, 26, 30, 33, 82, 37, 106, 118, 128, 133, 149, 150, 160, 178, 182, 186, 193, 195, 202, 203, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, and 484, and/or one of the deletions D183* and G184* in the count according to SEQ ID NO:2.

19. The cleaning agent according to claim 4, wherein the second amylase has amino acid substitutions at three or more of the positions 9, 26, 149, 182, 186, 202, 257, 295, 299, 323, 339, and 345 in the count according to SEQ ID NO:2.

20. The cleaning agent according to claim 19, wherein the second amylase has one or more of the substitutions and/or deletions at positions: 118, 183, 184, 195, 320, and 458 in the count according to SEQ ID NO:2.

21. The cleaning agent according to claim 20, wherein the second amylase has one or more of the following substitutions and/or deletions in the count according to SEQ ID NO:2: R118K, D183*, G184*, N195F, R320K, and/or R458K.

22. The cleaning agent according to claim 4, wherein the second amylase has the following amino acid substitutions and/or deletions in the count according to SEQ ID NO:2:
(i) M9L+M323T;
(ii) M9L+M202L/T/V/I+M323T;
(iii) M9L+N195F+M202L/T/V/I+M323T;
(iv) M9L+R118K+D183*+G184*+R320K+M323T+R458K;
(v) M9L+R118K+D183*+G184*+M202L/T/V/I+R320K+M323T+R458K;
(vi) M9L+G149A+G182T+G186A+M202L+T257I+Y295F+N299Y+M323T+A339S+E345R;
(vii) M9L+G149A+G182T+G186A+M202I+T257I+Y295F+N299Y+M323T+A339S+E345R;
(viii) M9L+R118K+G149A+G182T+D183*+G184*+G186A+M202L+T257I+Y295F+N299Y+R320K+M323T+A339S+E345R+R458K;
(ix) M9L+R118K+G149A+G182T+D183*+G184*+G186A+N195F+M202L+T257I+Y295F+N299Y+R320K+M323T+A339S+E345R+R458K;
(x) M9L+R118K+G149A+G182T+D183*+G184*+G186A+M202I+T257I+Y295F+N299Y+R320K+M323T+A339S+E345R+R458K;
(xi) M9L+R118K+D183*+D184*+N195F+M202L+R320K+M323T+R458K;
(xii) M9L+R118K+D183*+D184*+N195F+M202T+R320K+M323T+R458K;
(xiii) M9L+R118K+D183*+D184*+N195F+M202I+R320K+M323T+R458K;
(xiv) M9L+R118K+D183*+D184*+N195F+M202V+R320K+M323T+R458K;
(xv) M9L+R118K+N150H+D183*+D184*+N195F+M202L+V214T+R320K+M323T+R458K; or
(xvi) M9L+R118K+D183*+D184*+N195F+M202L+V214T+R320K+M323T+E345N+R458K.


SEQUENCE LISTING (10 sequences)

SEQ ID NO: 1 - protein, 485 aa, Bacillus sp. No.707
HHNGTNGTMMQYFEWYLPNDGNHWNRLNSDASNLKSKGITAVWIPPAWKGASQNDVGYGAYDLYDLGEFNQKGTVRTKYGTRSQLQAAVTSLKNNGIQVYGDVVMNHKGGADATEMVRAVEVNPNNRNQEVTGEYTIEAWTRFDFPGRGNTHSSFKWRWYHFDGVDWDQSRRLNNRIYKFRGHGKAWDWEVDTENGNYDYLMYADIDMDHPEVVNELRNWGVWYTNTLGLDGFRIDAVKHIKYSFTRDWINHVRSATGKNMFAVAEFWKNDLGAIENYLQKTNWNHSVFDVPLHYNLYNASKSGGNYDMRNIFNGTVVQRHPSHAVTFVDNHDSQPEEALESFVEEWFKPLAYALTLTREQGYPSVFYGDYYGIPTHGVPAMRSKIDPILEARQKYAYGKQNDYLDHHNIIGWTREGNTAHPNSGLATIMSDGAGGSKWMFVGRNKAGQVWSDITGNRTGTVTINADGWGNFSVNGGSVSIWVNK

SEQ ID NO: 2 - protein, 485 aa, Bacillus sp.
HHNGTNGTMMQYFEWYLPNDGNHWNRLRSDASNLKDKGISAVWIPPAWKGASQNDVGYGAYDLYDLGEFNQKGTIRTKYGTRNQLQAAVNALKSNGIQVYGDVVMNHKGGADATEMVRAVEVNPNNRNQEVSGEYTIEAWTKFDFPGRGNTHSNFKWRWYHFDGVDWDQSRKLNNRIYKFRGDGKGWDWEVDTENGNYDYLMYADIDMDHPEVVNELRNWGVWYTNTLGLDGFRIDAVKHIKYSFTRDWINHVRSATGKNMFAVAEFWKNDLGAIENYLNKTNWNHSVFDVPLHYNLYNASKSGGNYDMRQIFNGTVVQRHPMHAVTFVDNHDSQPEEALESFVEEWFKPLAYALTLTREQGYPSVFYGDYYGIPTHGVPAMKSKIDPILEARQKYAYGRQNDYLDHHNIIGWTREGNTAHPNSGLATIMSDGAGGNKWMFVGRNKAGQVWTDITGNRAGTVTINADGWGNFSVNGGSVSIWVNK

SEQ ID NO: 3 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 4 - protein, 269 aa, Bacillus alkalophilus PB92
AQSVPWGISRVQAPAAHNRGLTGSGVKVAVLDTGISTHPDLNIRGGASFVPGEPSTQDGNGHGTHVAGTIAALNNSIGVLGVAPNAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 5 - protein, 269 aa, Bacillus lentus
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGADGRGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 6 - protein, 269 aa, Artificial
  Optimized B. lentus subtilisin 309 variant
AQSVPWGIRRVQAPTAHNRGLTGSGVKVAVLDTGISTHPDLNIRGGASFVPGEPSTQDGNGHGTHAAGTIAALNNSIGVLGVAPSAELYAVKVLGASGSGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLDGTSMATPHVAGAAALVKQKNPSWSNVRIRNHLKNTATSLGSTNLYGSGLVNAEAATR

SEQ ID NO: 7 - protein, 270 aa, Artificial
  Optimized B. lentus subtilisin 309 variant
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGASGADGSVSSIAQGLEWAGNNGMHVANLSLGSPSPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 8 - protein, 269 aa, Artificial
  Bacillus alkalophilus PB92 protease mutant
AQSVPWGISRVQAPAAHNRGLTGSGVKVAVLDTGISTHPDLNIRGGASFVPGEPSTQDGNGHGTHVAGTIAALNNSIGVLGVAPNAELYAVKVLGASGSGSVSSIAQGLEWAGNNVMHVANLSLGLQAPSATLEQAVNSATSRGVLVVAASGNSGAGSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 9 - protein, 269 aa, Artificial
  Optimized B. lentus alkaline protease variant
AQSVPWGISRVQAPAAHNRGLTGSGVKVAVLDTGISTHPDLNIRGGASFVPGEPSTQDGNGHGTHVAGTIAALNNSIGVLGVAPSAELYAVKVLGADGEGAISSIAQGLEWAGNNGMHVANLSLGSPSPSATLEQAVNSATSRGVLVVAASGNSGASSISYPARYANAMAVGATDQNNNRASFSQYGAGLDIVAPGVNVQSTYPGSTYASLNGTSMATPHVAGAAALVKQKNPSWSNVQIRNHLKNTATSLGSTNLYGSGLVNAEAATR

SEQ ID NO: 10 - protein, 269 aa, Artificial
  Optimized B. lentus alkaline protease variant
AQTIPWGISRVQAPAAHNRGLTGSGVKVAVLDTGISTHPDLNIRGGASFVPGEPSTQDGNGHGTHVAGTIAALNNSIGVLGVAPSAELYAVKVLGADGEGAISSIAQGLEWAGNNGMHVANLSLGSPSPSATLEQAVNSATSRGVLVVAASGNSGASSISYPARYANAMAVGATDQNNNRASFSQYGAGLDIVAPGVNIQSTYPGSTYASLNGTSMATPHVAGAAALVKQKNPSWSNVQIRNHLKNTATSLGSTNLYGSGLVNAEAATR